(19) United States
(12) Patent Application Publication
(10) Pub. No.: US 2017/0085109 A1
(43) Pub. Date: Mar. 23, 2017

(54) POWER ADAPTER AND TERMINAL

(71) Applicant: Guangdong Oppo Mobile Telecommunications Corp., Ltd., Dongguan (CN)

(72) Inventor: Jialiang Zhang, Dongguan (CN)

(21) Appl. No.: 15/372,035

(22) Filed: Dec. 7, 2016

Related U.S. Application Data
(63) Continuation of application No. PCT/CN2015/074049, filed on Mar. 11, 2015.

(30) Foreign Application Priority Data
Nov. 11, 2014 (CN) PCT/CN2014/090845
Nov. 11, 2014 (CN) PCT/CN2014/090846
Nov. 11, 2014 (CN) PCT/CN2014/090847

(51) Int. Cl. H02J 7/00; H01M 10/42; H01M 10/46

(52) U.S. Cl. CPC H02J 7/0052; H01M 10/46; H01M 10/425; H01M 2010/4278; H01M 2220/30; H02J 2007/0059

(57) ABSTRACT

A power adapter and a terminal, and the power adapter includes a power conversion unit and a charging interface, the power conversion unit charging the terminal via the charging interface, and the power adapter further includes a communication unit, for performing bi-directional communication with the terminal via the charging interface to determine a charging mode of the terminal, and a voltage control unit and/or current control unit, for controlling the output voltage and/or output current of the power conversion unit according to the charging mode determined by the communication unit. The power adapter negotiates with the terminal about the charging mode through the communication unit, and the output voltage/output current of the power adapter is controlled according to the charging mode determined by the communication unit.

### CROSS-REFERENCE TO RELATED APPLICATIONS

This application is a continuation of International Application No. PCT/CN2015/074049, filed on Mar. 11, 2015, which claims priority to International Application Nos. PCT/CN2014/090847, PCT/CN2014/090846, and PCT/CN2014/090845, all filed on Nov. 11, 2014, the disclosures of all of which are herein incorporated by reference in their entireties.

### TECHNICAL FIELD

The present disclosure relates to charging field, and particularly to a power adapter and a terminal.

### BACKGROUND

In recent years, mobile phones (such as smart phones) are becoming more and more popular because of their intelligence and powerful functionality. Typically, the mobile phones need to be charged frequently because of high power consumption. At the same time, as battery capacity increasing, charging time thereof is becoming longer. In this way, there arises the need for quick charging.

In some instances, in order to realize quick charging, an output current or output voltage of a power adapter can be increased directly without taking into account the capacity of a mobile phone. This may lead to the mobile phone overheating or even burning, thus the service life of the mobile phone may be reduced.

### SUMMARY

Disclosed herein are implementations of a power adapter, comprising a power conversion unit and a charging interface, the power conversion unit being configured to charge a terminal via the charging interface, wherein the power adapter further comprises a communication unit, configured to perform bi-directional communication with the terminal via the charging interface to determine a charging mode of the terminal, and at least one of a voltage control unit and a current control unit, configured to control at least one of an output voltage and output current of the power conversion unit according to the charging mode determined by the communication unit.

Disclosed herein are also implementations of a terminal, comprising a battery and a charging interface, the terminal being configured to introduce charging current from a power adapter via the charging interface for charging the battery, further comprising a communication unit, configured to perform bi-directional communication with the power adapter via the charging interface, wherein the power adapter determines a charging mode of the terminal.

Disclosed herein are also implementations of an apparatus for charging management, comprising a power converter and a charging interface, the power converter being configured to charge a terminal via the charging interface, further comprising a transceiver, configured to perform bi-directional communication with the terminal via the charging interface to transmit or receive instructions to and from the terminal, respectively, a processor, configured to determine a charging mode of the terminal according to the bi-directional communication of the transceiver, and a controller, configured to control at least one of an output voltage and output current of the power converter according to the charging mode determined by the processor.

### BRIEF DESCRIPTION OF THE DRAWINGS

In order to illustrate the technical solutions of the present disclosure or the related art more clearly, a brief description of the accompanying drawings used herein is given below. Obviously, the drawings listed below are only examples, and a person skilled in the art should be noted that, other drawings can also be obtained on the basis of these exemplary drawings without creative work.

FIG. 1 is a schematic block diagram illustrating a power adapter according to an implementation of the present disclosure.

FIG. 2A, 2B is a schematic block diagram illustrating a terminal according to an implementation of the present disclosure.

FIG. 3 is a schematic diagram illustrating a quick charging structure according to an implementation of the present disclosure.

FIG. 4 is a schematic diagram illustrating a communication mode between the power adapter and the terminal according to an implementation of the present disclosure.

FIG. 5 is a schematic diagram illustrating a communication process between the power adapter and the terminal according to an implementation of the present disclosure.

FIG. 6 is schematic diagram illustrating a cable structure according to an implementation of the present disclosure.

FIG. 7 is a schematic block diagram illustrating a charging control apparatus according to an implementation of the present disclosure.

### DETAILED DESCRIPTION

Technical solutions of implementations of the present disclosure will now be described clearly and completely taken in conjunction with the accompanying drawings; it will be apparent to one of ordinary skill in the art that, the implementations described below are merely a part of the disclosure and other implementations obtained out of them without creative work will fall into the protection range of the present disclosure either.

In order to facilitate understanding rather than any form of restriction, in the present disclosure, typically but not necessarily, “quick charging” means that, within about 30 minutes from the start of the charging, the terminal enters a charging state where the average current is not less than 3 A or the total power charged is not less than about 60% of the rated capacity.

Implementation 1

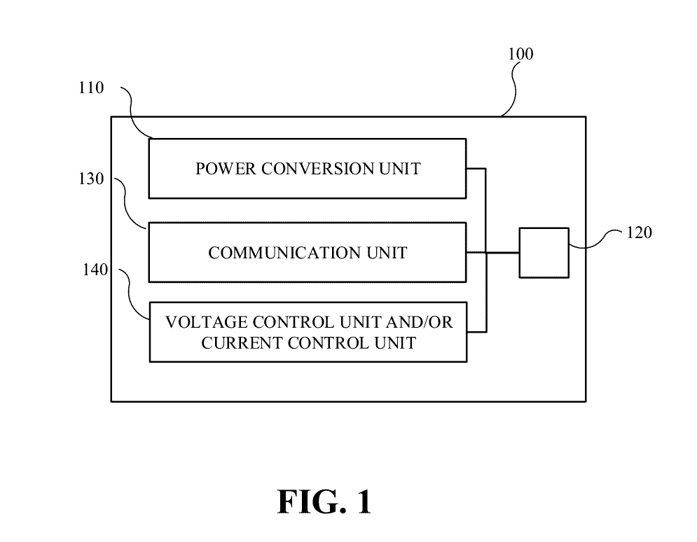

According to implementation 1, it is provided a power adapter. FIG. 1 is a schematic block diagram illustrating the power adapter according to implementation 1 of the present disclosure. As shown in FIG. 1, a power adapter 100 includes a power conversion unit 110 (for example, converter) and a charging interface 120 (for example, USB interface). The power conversion unit 110 charges a terminal via the charging interface 120.

The power adapter 100 further includes a communication unit 130 (can be a communication device such as a transceiver) and a voltage control unit and/or current control unit 140 (for example, controller). The communication unit 130 is configured to perform bi-directional communication with the terminal via the charging interface 120 so as to determine a charging mode of the terminal. The voltage control unit and/or current control unit 140 is configured to control an output voltage and/or output current of the power conversion unit 110 according to the charging mode determined by the communication unit 130.

In an implementation, the power adapter can negotiate with the terminal about the charging mode via the communication unit, and the power adapter can control the output voltage/output current thereof according to the charging mode determined by the communication unit, whereby effectively avoid heating or even burning phenomena of a mobile phone caused by aimless increase of the output current or output voltage of the power adapter.

As an example, the charging mode includes a normal charging mode and a first quick charging mode. A charging current of the power adapter 100 is higher in the first quick charging mode than in the normal charging mode.

Specifically, in the first quick charging mode, charging power and speed of the terminal can be improved by increasing the output current (for example, greater than 2.5 A) of the power adapter. In the normal charging mode, a rated output voltage of the power adapter can be 5V, and a rated output current of the power adapter can be less than or equal to 2.5 A.

Optionally, in an implementation, in the first quick charging mode, the charging current of the power adapter 100 can be greater than 2.5 A, for example, can be 5 A, with a tolerance of ±5%. Or, the rated output current of the power adapter is greater than 2.5 A.

In an example, the charging mode includes a normal charging mode and a second quick charging mode. A charging voltage of the power adapter 100 is higher in the second quick charging mode than in the normal charging mode.

Specifically, in the second quick charging mode, the charging power and speed of the terminal can be improved by increasing the output voltage (for example, 9V or 12V) of the power adapter.

Optionally, in an implementation, in the second quick charging mode, the charging voltage of the power adapter 100 is 9V or 12V; or, the rated output voltage of the power adapter 100 is 5V, 9V, or 12V, with a tolerance of ±5%.

As an example, in an implementation, the charging mode includes a normal charging mode, a first quick charging mode, and a second quick charging mode. The charging current of the power adapter 100 is higher in the first quick charging mode than in the normal charging mode, and charging voltage of the power adapter 100 is higher in the second quick charging mode than in the normal charging mode. The current control unit is configured to adjust the output current of the power conversion unit 110 to the charging current corresponding to the first quick charging mode, if the charging mode of the terminal determined by the communication unit 130 is the first quick charging mode; the voltage control unit is configured to adjust the output voltage of the power conversion unit 110 to the charging voltage corresponding to the second quick charging mode, if the charging mode of the terminal determined by the communication unit 130 is the second quick charging mode.

In one implementation, the charging interface 120 of the power adapter 100 and a charging cable connecting the power adapter 100 and the terminal adopt a separated design. The power adapter 100 further includes: an identification unit, configured to identify a charging mode supported by the charging cable; the communication unit 130 is further configured to determine the charging mode of the terminal according to the charging mode supported by the charging cable identified by the identification unit.

In an implementation, the identification unit is configured to transmit an identification code to a control chip in the charging cable, and then receive a feedback code returned from the control chip and determine whether the feedback code is correct; it is determined that the charging cable supports quick charging if the feedback code is correct, and it is determined that the charging cable does not support quick charging if the feedback code is incorrect.

As an example, the charging mode includes a normal charging mode and a quick charging mode, the charging current of the power adapter 100 is higher in the quick charging mode than in the normal charging mode; the communication unit 130 is configured to determine that a final charging mode is the quick charging mode, if the charging mode of the terminal determined by the communication unit 130 is the quick charging mode and the quick charging mode is supported by the charging cable; otherwise, determine that the final charging mode is the normal charging mode.

Optionally, in an implementation, the charging interface 120 and the charging cable use a USB A-type interface for connection.

Specifically, in an implementation, the communication unit 130 is configured to transmit a query message to the terminal, and then receive a feedback message returned by the terminal and determine the charging mode of the terminal according to the feedback message. The query message includes at least one of the following information: information for inquiring whether the terminal supports quick charging; information for inquiring a path impedance magnitude of the terminal; information for inquiring whether the voltage output by the power adapter 100 is equal to a battery voltage of the terminal; information for inquiring a maximum charge current allowed by the terminal; and information for inquiring the battery voltage of the terminal at present or whether a battery of the terminal supports quick charging.

Furthermore, the power adapter can be required to meet the following electrical performance requirements:

Output Voltage Ripple

| | Simulated load test | |
|---|---|---|
| Input voltage | condition | Output ripple limit |
| 100-240 Vac/50-60 Hz | 0-reference output | ≦200 mV peak to peak |
| | current | value |

Short-Circuit Current

| | Simulated load test | |
|---|---|---|
| Input voltage | condition | Short-circuit current limit |
| 100-240 Vac/50-60 Hz | Short-circuit | Less than 1.5 times the rated |
| | | output current, and no |
| | | more than 2500 mA |

Regardless of whether the power adapter is plugged into the power supply, current flowing from the terminal to the power adapter should be no greater than 5 mA.

Touch current flowing from an alternating current (AC) power supply to an output port via the power adapter should be no greater than 20 uA.

Safety performance should be in line with the requirements of GB 4943.1.

Furthermore, the quick charging power adapter can possess functions of identifying a quick charging data line and detecting abnormal interface plug-in. The quick charging power adapter should have automatic protection function of a short circuit. And the power adapter should be able to resume work automatically after trouble shooting.

Moreover, there can be some requirements for the energy efficiency of the power adapter. For example, the actual average efficiency of the power adapter should meet the following condition:

Average efficiency≧0.0750*Ln(Pno)+0.561

Wherein “Pno” refers to the rated output power (that is, rated output voltage multiplied by rated output current) of the power adapter.

Energy Consumption Without Load

| Input voltage | Simulated load test condition | Power consumption limit |
|---|---|---|
| 220 V/50 Hz | Open-circuit | Less than 150 mW |

As to plug force and plug life (namely, resistance to plug), the following conditions shall be satisfied:

With regard to plug operation (in other words, plug in and plug out) between a connecting plug and a connecting socket, if plug rate is no more than 12.5 mm/min (that is, the maximum rate), the fore required for inserting the connecting plug into the connecting socket completely should be no more than 35N, and the force required for pulling the connecting plug out of the connecting socket completely should be no less than 10N.

Assume 200 plug-in/plug-out cycles per hour, mechanical structure should not be damaged after 3000 cycles performed at the maximum rate, and the force required for pulling the connecting plug out of the connecting socket completely should be no less than 8N.

Implementation 2

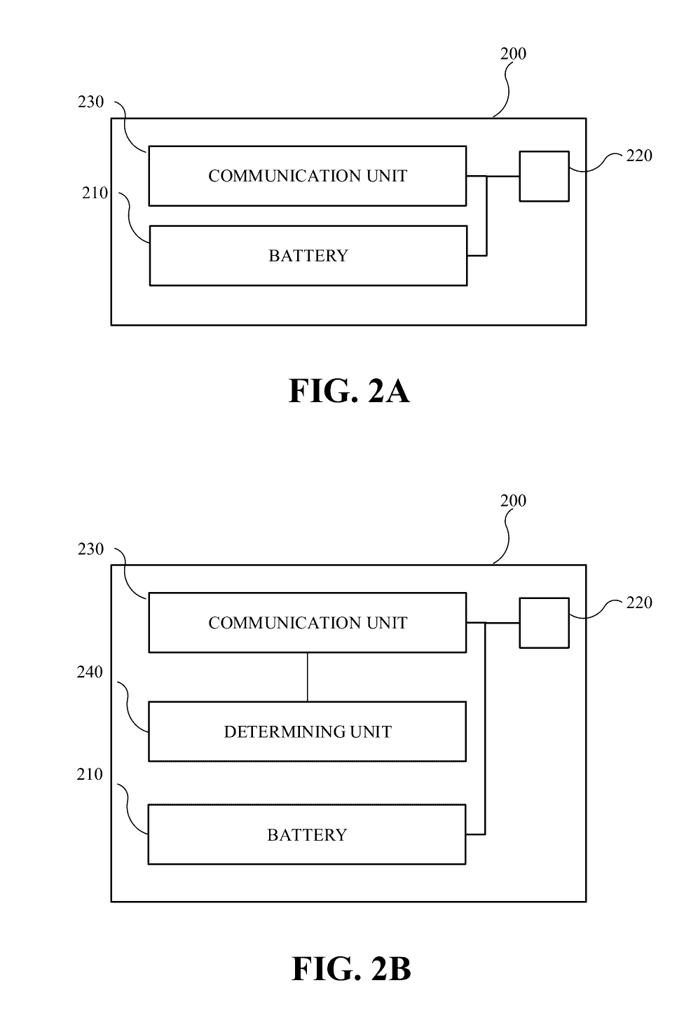

According to implementation 2, it is provided a terminal. FIG. 2 is a schematic block diagram illustrating the terminal according to implementation 2 of the present disclosure. As shown in FIG. 2, a terminal 200 includes a battery 219 and a charging interface 220. The terminal 200 introduces charging current from a power adapter via the charging interface 220 so as to charge the battery 210.

The terminal 200 further includes: a communication unit 230 (for example, a communication device such as a transceiver), configured to perform bi-directional communication with the power adapter via the charging interface 220 such that the power adapter can determine a charging mode of the terminal 200.

In an implementation, as shown in FIG. 2B, the terminal can further include a determining unit 240, which is connected with the communication unit 230 and is configured to determine whether quick charging is allowed at the terminal 200 according to a battery voltage and temperature of the terminal 200. Based on the determination of the determining unit 240, the communication unit 230 can send an instruction (such as Instruction 4 described in the following) to the power adapter to indicate whether quick charging is allowed, and then the power adapter can determine the charging mode of the terminal.

In this implementation, the power adapter can negotiate with the terminal about the charging mode via the communication unit, and the power adapter can control the output voltage/output current thereof according to the charging mode determined by the communication unit, whereby effectively avoid heating or even burning phenomena of a mobile phone caused by aimless increase of the output current or output voltage of the power adapter.

The charging interface of the terminal can be compatible with Micro-USB Type-B or Type-C interface specification.

The terminal shall meet the following electrical performance requirements: the charging interface and charging control circuit should be able to charge normally and safely according to their own needs; the maximum temperature of the terminal should be no higher than 55° C. during a charging process and phenomenon such as fire, explosion, and circuit damage should not occur.

Moreover, there can be an overvoltage protection device in a charging control circuit within the terminal. The overvoltage protection device will be started if the charging voltage is higher than 12V (to be determined). During boot up of the overvoltage protection device, absorbing current thereof should be no more than 20 mA. The maximum temperature of the terminal should be not higher than 55° C. throughout the process; phenomenon such as fire, explosion, and circuit damage should not occur. The terminal should be able to work properly after recovery.

Terminal with quick charging function should be able to identify whether the power adapter meet quick charging requirements, can monitor the entire charging process in real time and adopt a corresponding charging mode.

As an example, the charging mode includes a normal charging mode and a first quick charging mode; a charging current is higher in the first quick charging mode than in the normal charging mode.

In the first quick charging mode, for example, the charging current is higher than 2.5 A.

As an example, the charging mode includes a normal charging mode and a second quick charging mode; a charging voltage is higher in the second quick charging mode than in the normal charging mode.

In the second quick charging mode, for example, the charging voltage of the power adapter is 9V or 12V.

The communication unit is configured to receive a query message transmitted from the power adapter and transmit a feedback message to the power adapter, wherein the feedback message includes at least one of the following information: information for indicating whether the terminal 200 supports quick charging; information for indicating a path impedance magnitude of the terminal 200; information for indicating whether the voltage output by the power adapter is equal to the voltage of the battery 210 in the terminal 200; information for indicating a maximum charge current allowed by the terminal 200; and information for indicating the voltage of the battery 210 of the terminal 200 at present or whether the battery 210 of the terminal 200 supports quick charging.

The battery in the terminal can meet the following requirements and have the following functions:

1) The battery can read voltage and current values of an electric core in real time and transmit the values to the terminal accurately; wherein the deviation of voltage and current is not allowed to exceed a charge limit of the electric core.

2) In the process of charging, temperature rise of various components of the battery should be no more than 15° C.

3) With regard to cycle life of the battery, under conditions of temperature upper limit and lower limit, quick charging life test should satisfy requirements as follows: a capacity retention rate should be higher than 80% after 500 cycles.

4) Actual capacity is equal to or higher than rated capacity.

5) GB 31241 requirement is met.

6) The battery should have overvoltage protection function of two-level protection so as to prevent overvoltage of the charging of the electric core. If the voltage of the electric core of the battery is higher than a rated voltage value (for example, the voltage of the electric core=rated voltage value +0.1V, currently, 4.4V; and to be determined in the future), a charging path of a battery protection board should be able to automatically cut off so as to start over an overvoltage protection mechanism.

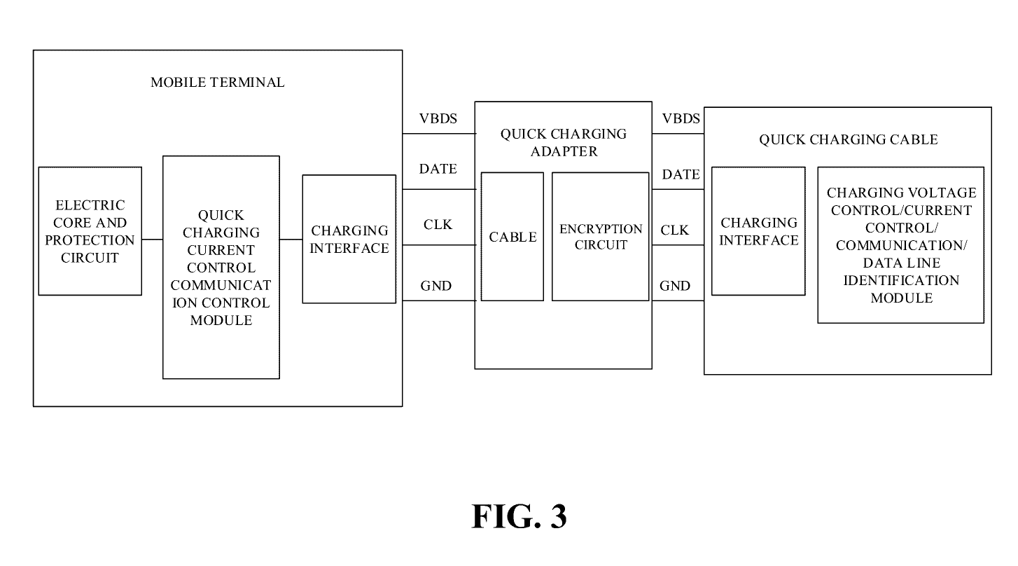

Implementations of the present disclosure will be described in detail combined with specific examples. Examples illustrated in FIG. 3-FIG. 6 are used to help technical personnel in the field to understand implementations of the present disclosure, and not intend to limit the implementations of the present disclosure to a specific value or a specific scene illustrated. Various equivalent modifications and variations made according to the examples illustrated in FIG. 3-FIG. 6 shall fall into the protection range of the present disclosure.

FIG. 3 illustrates a quick charging system framework. As shown in FIG. 3, the quick charging system includes: a mobile terminal including a battery, a quick charging cable, and a quick charging adapter. The mobile terminal typically includes an electric core and a protection circuit thereof, a quick charging current control circuit module, a communication control module, and a charging interface. An encryption circuit module for identification of the power adapter and the terminal can be arranged in the charging cable, and specific implementations of the encryption circuit module can be set by manufactures. The quick charging adapter includes a charging interface, and a charging voltage control/current control/communication/data line identification module. After handshake communication between the terminal and the adapter, it will be determined that whether quick charging functional requirements are satisfied, and then a suitable quick charging mode will be determined. After that, the power adapter will supply corresponding voltage and current in order to charge the terminal. The power adapter and the charging cable adopt a separated design, and a USB Type-A interface can be used for connection.

The design of the charging adapter can take into account the vertical and horizontal compatibility of the product. Among which the vertical compatibility means that the quick charging adapter should be able to identify whether the cable and the terminal meet quick charging requirements and take a corresponding charging mode; moreover, the terminal with quick charging function should be able to identify whether the adapter meets quick charging requirements and take a corresponding charging mode. The horizontal compatibility means that the adapter with quick charging function should be able to provide corresponding quick charging for all terminals with quick charging function; on the other hand, the terminal with quick charging function should be able to identify all adapters with quick charging function and perform quick charging.

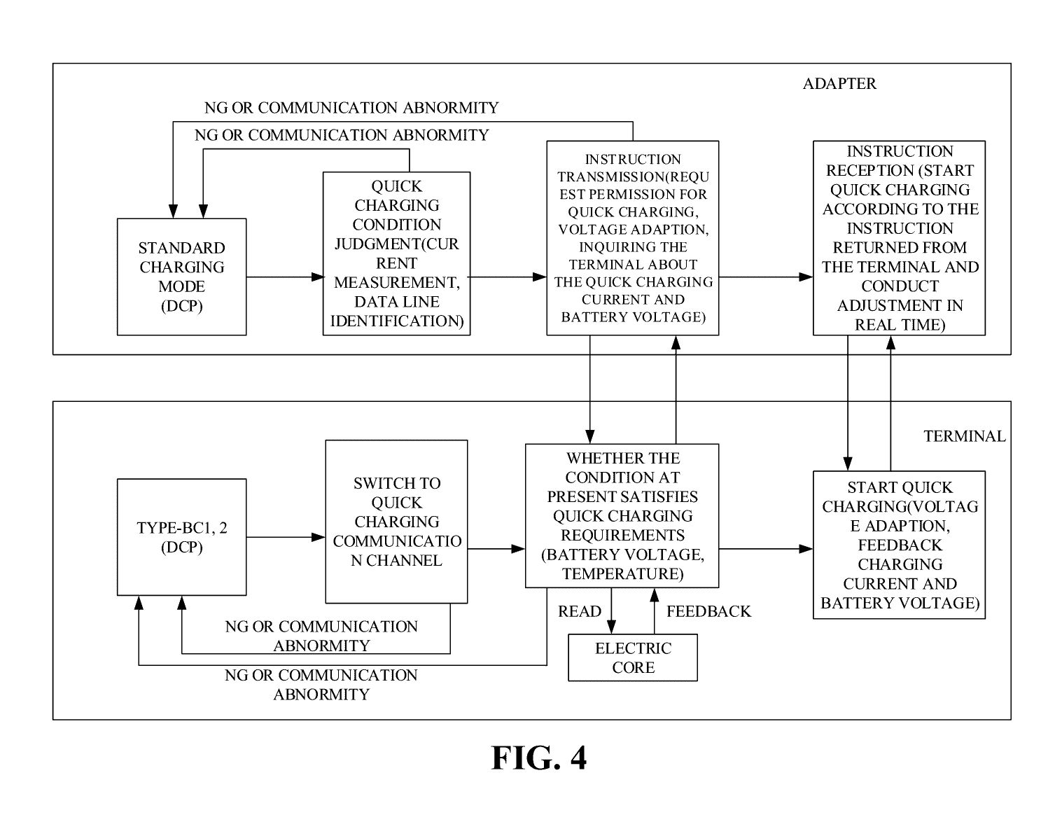

FIG. 4 is a schematic diagram illustrating a quick charging communication process. In FIG. 4, instructions transmitted by the adapter (in the following, transmitted instruction) and instructions returned by the mobile terminal (in the following, returned instruction) are open to various interpretations.

In FIG. 4, at the adapter side, the adapter is in standard charging mode (DCP). If it is determined that quick charging conditions (current measurement, data line identification) are satisfied, the adapter will send instructions (quick charging request, voltage adaption, inquiring quick charging current and battery voltage) to the terminal and receive instructions returned from the terminal. Additionally, the power adaptor can start over quick charging and adjust in real time according to the instructions returned from the terminal.

At the terminal side, the terminal will switch to a quick charging communication channel, and if it is determined that quick charging requirements (such as the battery voltage, and temperature) are satisfied, quick charging will be started along with voltage adaption and charging current and battery voltage feedback. At the power adapter side or the terminal side, during the process, communication abnormality may occur.

Examples of instructions are illustrated below, but the present disclosure is not limited thereto.

1) Transmitted instruction 1: used for the adapter to inquiry the terminal whether quick charging is allowed and inquiry a path impedance magnitude of the terminal; returned instruction 1: used for the terminal to feedback to the adapter whether the terminal supports quick charging and the path impedance magnitude of the terminal.

2) Transmitted instruction 2: used for the adapter to inquiry whether the voltage of the adapter at present matches (in other words, equals to) a battery voltage; returned instruction 2: used for the terminal to feedback to the adapter that the voltage of the adapter at present is higher than, equal to, or less than the battery voltage.

3) Transmitted instruction 3: used for the adapter to inquiry the terminal about a maximum charge current allowed at present; returned instruction 3: used for the terminal to feedback the maximum charge current allowed at present to the adapter.

4) Transmitted instruction 4: used for the adapter to inquiry a battery voltage of the terminal at present and whether quick charging is allowed; returned instruction 4: used for the terminal to feedback the battery voltage at present and whether quick charging can be launched to the adapter.

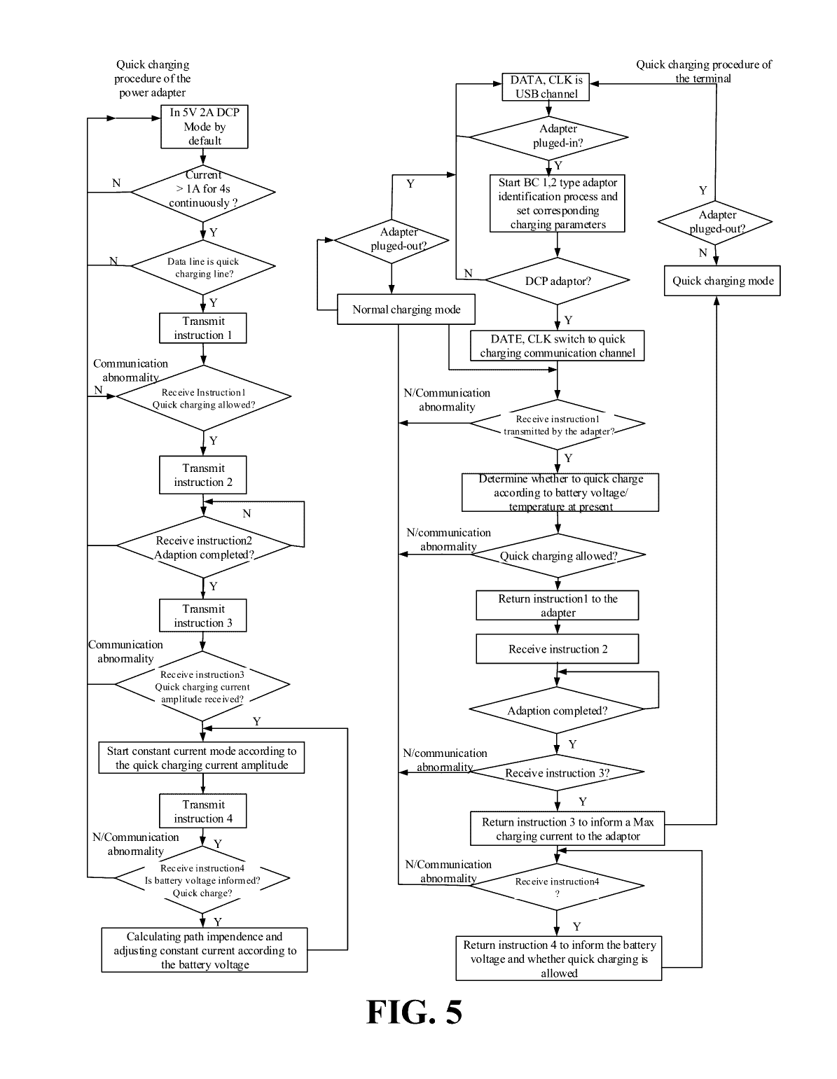

FIG. 5 is a schematic flow chart illustrating a process of determining the quick charging mode via bidirectional communication between the power adapter and the terminal. In FIG. 5, communication processes of the power adapter are shown on the left, and communication processes of the terminal are shown on the right. Each instruction in interaction in FIG. 5 can be defined as follows.

Transmitted instruction 1: used for the adapter to inquiry the terminal whether quick charging is allowed and inquiry a path impedance magnitude of the terminal. After receiving instruction 1, the terminal will decide whether quick charging can be conducted according to the battery voltage and temperature at present.

Returned instruction 1: used for the terminal to inform the adapter whether quick charging is allowed and the path impedance magnitude of the terminal.

Transmitted instruction 2: used for the adapter to inquiry whether the voltage of the adapter at present equals to a battery voltage. In other words, the transmitted instruction 2 is used to complete adaptation between the voltage of the power adapter and the battery voltage.

Returned instruction 2: used for the terminal to inform the adapter that the voltage of the adapter at present is higher than, equal to, or less than the battery voltage.

Transmitted instruction 3: used for the adapter to inquiry about a maximum charge current allowed by the terminal at present.

Returned instruction 3: used for the terminal to inform the adapter the maximum charge current allowed at present. Additionally, the power adapter will start over a constant current mode according to the charging current magnitude received.

Transmitted instruction 4: used for the adapter to inquiry a battery voltage of the terminal at present and whether quick charging is allowed.

Returned instruction 4: used for the terminal to inform the adapter the battery voltage at present and whether quick charging can be launched. The power adapter will calculate the path impedance and adjust the constant current according to the battery voltage received.

As shown in FIG. 5, at the power adapter side, at the beginning, the adapter is in 5V 2 A DCP mode by default. If the current of the power adapter is larger than 1 A for continuous 4 s, and the data line is a quick charging data line, the power adapter will transmit the instructions described above to the terminal.

At the terminal side, DATE, CLK is in USB channel at the beginning. When it is determined that the power adapter is plugged-in, BC 1, 2 type adapter identification process will be started and a corresponding charging current will be set. Thereafter, if it is detected that the adapter is a DCP adapter, DATE and CLK will switch to a quick charging communication channel for interaction with the adapter; specifically, the terminal will receive instructions transmitted from the adapter and return feedback instructions to the adapter.

Furthermore, the structure and material of the cable between the terminal and the power adapter can be required to meet the following requirements or indexes.

1. USB Type-A structure should be adopted at the input end of the cable, Micro-USB Type-B or Type-C interface specification should be compatible at the output end of the cable.

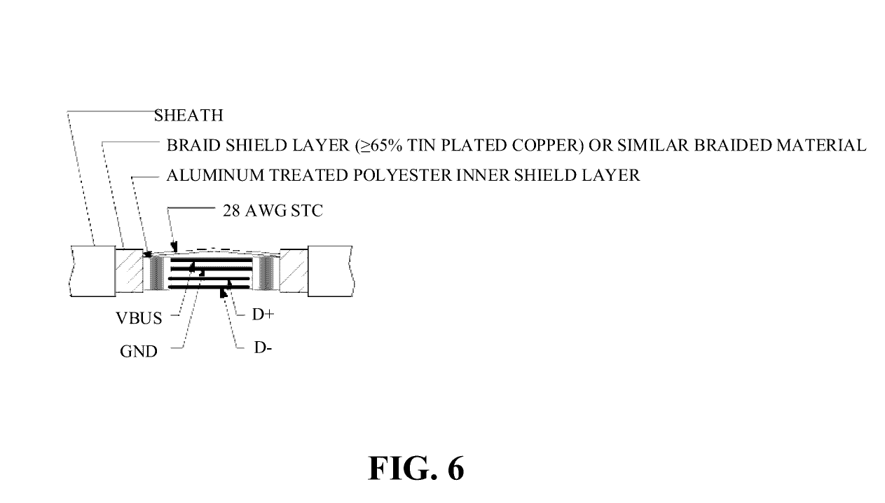

The structure of the connecting cable used for data transmission and power supply function should comply with the requirements illustrated in FIG. 6 (as same as the connecting cable of USB Type-A). The connecting cable is composed of four wires, two of them are power supply wires (VBUS is the positive electrode of the power supply, while GND is the negative electrode of the power supply), and the other two are signal wires. As shown in FIG. 6, the structure of the cable can include a sheath, a Braid shield layer (≧65% tin plated copper) or similar braided material layer, and an aluminum treated polyester inner shield layer. The specification of the cable can be 28 AWG STC for example.

The material of the cable should meet the requirements of GB/T 22727.1. In the material, Polycyclic Aromatic Hydrocarbons (PAHs) content is less than 200 mg/kg, and Benzopyrene content is less than 20 mg/kg.

The material can be made of polyethylene (PE) or other preferred materials.

The length of the connecting cable should be less than 200 cm.

The sheath should surround a fully shield power supply and signal line pair, and should be directly connected with an external shield of a tin plated copper wire.

Maximum resistance of a cable used for supporting quick charging with increasing voltage should be no more than 0.232 Ω/m.

Maximum resistance of a cable used for supporting quick charging with increasing current should be no more than 0.1 Ωm.

Insulation resistance of a connecting interface of USB Type-A and Micro-USB Type B should be no less than 1000 MΩ.

Insulation materials of the connecting interface of USB Type-A should be able to withstand an AC voltage effective value of 500V; insulation materials of the connecting interface of Micro-USB Type-B should be able to withstand an AC voltage effective value of 100V.

There should be no breakdown, spark, or arcing phenomenon in a voltage-withstand test lasted for 1 min. Leakage should not exceed 0.5 mA.

Flame retardancy of the insulation material of the cable (does not contain connector parts) should reach V-1 grade or better grades.

With regard to plug operation (in other words, plug in and plug out) between a connecting plug and a connecting socket, if plug rate is no more than 12.5 mm/min (that is, the maximum rate), the fore required for inserting the connecting plug into the connecting socket completely should be no more than 35N, and the fore required for pulling the connecting plug out of the connecting socket completely should be no less than 10N.

The mechanical structure should not be damaged after 3000 cycles performed at a maximum rate of 200 plug-in/plug-out cycles per hour, and the fore required for pulling the connecting plug out of the connecting socket completely should be no less than 8N.

Implementation 3

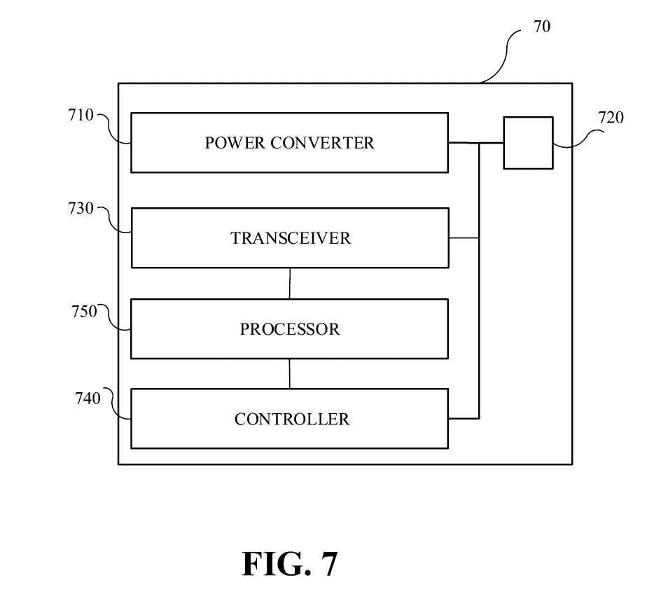

According to implementation 3 of the present disclosure, it is provided a charging control apparatus. FIG. 7 is a schematic block diagram illustrating the charging control apparatus. As shown in FIG. 7, the charging control apparatus 70 includes a power converter 710 and a charging interface 720, the power converter 710 is configured to charge a terminal (such as the terminal of implementation 2 described above) via the charging interface 720. The apparatus further comprises a transceiver 730, a processor 750, and a controller 740.

The transceiver 730 is configured to perform bi-directional communication with the terminal via the charging interface 720 so as to transmit/receive instructions to/from the terminal. The processor 750 is configured to determine a charging mode of the terminal according to the communication of the transceiver 730. The controller 740 is configured to control an output voltage and/or output current of the power converter 710 according to the charging mode determined by the processor 750.

As to details of the charging control apparatus, please refer to the description of the power adapter according to implementation 1 and/or the description of the terminal according to implementation 2. It will not go into much detail here in order to avoid redundancy.

A person skilled in the art will understand, exemplary units or algorithm steps described in any of the implementations can be achieved via electronic hardware or a combination of electronic hardware and computer software. Whether hardware or software should be adopted depends on design constraints and specific application of technical schemes. Respective specific application can use different methods or manners to achieve the function described in the implementations, which will fall into the protection scope of the present disclosure.

Specific operations of the device, system, and the unit or module can refer to corresponding description of the method according to the implementation.

Besides, the device, system, and method described herein can be achieved in other manners. Configurations of the device according to the implementation described above are only exemplary; the division of units in the device is a kind of division according to logical function, therefore there can be other divisions in practice. For example, multiple units or components can be combined or integrated into another system; or, some features can be ignored while some units need not to be executed. On the other hand, various function units can be integrated into one processing unit; two or more than two units can be integrated into one unit; or, each unit is physically separate.

On the other hand, units or components illustrated as separated components can be physically separate, components illustrated as units can be physical units, that is, they can be located in one place, or can be dispersed in multiple network units. All or a part of the units or components illustrated above can be chosen to achieve the purpose of the present disclosure according to actual needs.

Furthermore, various function units can be integrated into one processing unit; two or more than two units can be integrated into one unit; or, each unit is physically separate.

Operations or functions of technical schemes according to implementations of the present disclosure, which are achieved in the form of software functional units and can be sold or used as an independent product, can be stored in a computer readable storage medium. According to this, all or a part of the technical schemes of the present disclosure can be realized in the form of software products which can be stored in a storage medium. The storage medium includes USB disk, Read Only Memory (ROM), Random Access Memory (RAM), magnetic disk, CD, and any other medium that can be configured to store computer-readable program codes or instructions. The computer-readable program code, when executed on a data-processing apparatus (can be personal computer, server, or network equipment), adapted to perform all or a part of the methods as described in the above-mentioned implementations.

The foregoing descriptions are merely preferred implementations of the present disclosure, rather than limiting the present disclosure. Various modifications and alterations may be made to the present disclosure for those skilled in the art. Any modification, equivalent substitution, improvement or the like made within the spirit and principle of the present disclosure shall fall into the protection scope of the present disclosure.

What is claimed is:

1. A power adapter comprising a power conversion unit and a charging interface, the power conversion unit configured to charge a terminal via the charging interface, the power adapter further comprising:
a communication unit, configured to perform bi-directional communication with the terminal via the charging interface to determine a charging mode of the terminal; and
at least one of a voltage control unit and a current control unit, configured to control at least one of an output voltage and output current of the power conversion unit according to the charging mode determined by the communication unit.

2. The power adapter of claim 1, wherein the charging mode comprises a normal charging mode and a first quick charging mode, and a charging current of the power adapter is higher in the first quick charging mode than in the normal charging mode.

3. The power adapter of claim 2, wherein in the first quick charging mode, the charging current of the power adapter is higher than 2.5 A, or, a rated output current of the power adapter is higher than 2.5 A.

4. The power adapter of claim 1, wherein the charging mode comprises a normal charging mode and a second quick charging mode, and a charging voltage of the power adapter is higher in the second quick charging mode than in the normal charging mode.

5. The power adapter of claim 4, wherein in the second quick charging mode, the charging voltage of the power adapter is 9V or 12V, or, a rated output voltage of the power adapter is 5V, 9V, or 12V.

6. The power adapter of claim 1, wherein
the charging mode comprises a normal charging mode, a first quick charging mode, and a second quick charging mode, a charging current of the power adapter is higher in the first quick charging mode than in the normal charging mode, and a charging voltage of the power adapter is higher in the second quick charging mode than in the normal charging mode;
the current control unit is configured to adjust the output current of the power conversion unit to a charging current corresponding to the first quick charging mode when the charging mode of the terminal determined by the communication unit is the first quick charging mode; and
the voltage control unit is configured to adjust the output voltage of the power conversion unit to a charging voltage corresponding to the second quick charging mode when the charging mode of the terminal determined by the communication unit is the second quick charging mode.

7. The power adapter of claim 1, wherein the charging interface of the power adapter and a charging cable connecting the power adapter and the terminal adopt separated designs, the power adapter further comprises:
an identification unit, configured to identify a charging mode supported by the charging cable, wherein the communication unit is further configured to determine the charging mode of the terminal according to the charging mode supported by the charging cable identified by the identification unit.

8. The power adapter of claim 7, wherein the identification unit is configured to:
transmit an identification code to a control chip in the charging cable, receive a feedback code returned from the control chip, and determine whether the feedback code is correct;
it is determined that the charging cable supports quick charging when the feedback code is correct; and
it is determined that the charging cable does not support quick charging when the feedback code is incorrect.

9. The power adapter of claim 7, wherein
the charging mode comprises a normal charging mode and a quick charging mode, and a charging current of the power adapter is higher in the quick charging mode than in the normal charging mode; and
the communication unit is configured to:
determine that a final charging mode is the quick charging mode, when the charging mode of the terminal determined by the communication unit is the quick charging mode and the quick charging mode is supported by the charging cable; and
determine that the final charging mode is the normal charging mode when the charging mode of the terminal determined by the communication unit is not the quick charging mode or the quick charging mode is not supported by the charging cable.

10. The power adapter of claim 7, wherein the charging interface and the charging cable use a USB Type-A interface for connection.

11. The power adapter of claim 1, wherein the communication unit is configured to transmit a query message to the terminal, receive a feedback message returned by the terminal, and determine the charging mode of the terminal according to the feedback message, the query message comprising at least one of:
information for inquiring whether the terminal supports quick charging;
information for inquiring a path impedance magnitude of the terminal;
information for inquiring whether the output voltage by the power adapter is equal to a battery voltage of the terminal;
information for inquiring a maximum charge current allowed by the terminal; and
information for inquiring the battery voltage of the terminal at present or whether a battery of the terminal supports quick charging.

12. A terminal comprising a battery and a charging interface, the terminal configured to introduce charging current from a power adapter via the charging interface for charging the battery, and terminal further comprising:
a communication unit, configured to perform bi-directional communication with the power adapter via the charging interface, wherein the power adapter determines a charging mode of the terminal.

13. The terminal of claim 12, wherein the charging mode comprises a normal charging mode and a first quick charging mode, and the charging current is higher in the first quick charging mode than in the normal charging mode.

14. The terminal of claim 13, wherein in the first quick charging mode, the charging current is higher than 2.5 A.

15. The terminal of claim 12, wherein the charging mode comprises a normal charging mode and a second quick charging mode, and a charging voltage is higher in the second quick charging mode than in the normal charging mode.

16. The terminal of claim 15, wherein, in the second quick charging mode, the charging voltage of the power adapter is 9V or 12V.

17. The terminal of claim 12, wherein the communication unit is configured to receive a query message transmitted from the power adapter and transmit a feedback message to the power adapter, the feedback message comprising at least one of:
information for indicating whether the terminal supports quick charging;
information for indicating a path impedance magnitude of the terminal;
information for indicating whether a voltage output by the power adapter is equal to a battery voltage of the terminal;
information for indicating a maximum charge current allowed by the terminal; and
information for indicating the battery voltage of the terminal at present or whether the battery of the terminal supports quick charging.

18. The terminal of claim 12, wherein the terminal further comprises a determining unit, connected with the communication unit and configured to determine whether quick charging is allowed at the terminal according to a battery voltage and temperature of the terminal.

19. An apparatus for charging management comprising a power converter and a charging interface, the power converter configured to charge a terminal via the charging interface, the apparatus further comprising:
a transceiver, configured to perform bi-directional communication with the terminal via the charging interface to transmit or receive instructions to or from the terminal;
a processor, configured to determine a charging mode of the terminal according to the bi-directional communication of the transceiver; and
a controller, configured to control at least one of an output voltage and an output current of the power converter according to the charging mode determined by the processor.

20. The apparatus of claim 19, wherein at least one of:
the charging mode comprises a normal charging mode and a first quick charging mode, a charging current of the apparatus is higher in the first quick charging mode than in the normal charging mode;
the charging mode comprises a normal charging mode and a second quick charging mode, a charging voltage of the apparatus is higher in the second quick charging mode than in the normal charging mode; and
the charging mode comprises a normal charging mode and a quick charging mode, and a charging current of the apparatus is higher in the quick charging mode than in the normal charging mode.
